(19) United States
(12) Patent Application Publication
(10) Pub. No.: US 2018/0132026 A1
(43) Pub. Date: May 10, 2018

(54) MODULAR WIRELESS EARBUDS

(71) Applicant: Ashley Chloe, Inc., San Mateo, CA (US)

(72) Inventors: Anson Liang, San Mateo, CA (US); Angela Pan, San Mateo, CA (US); Guangxin Xing, Shenzhen (CN)

(21) Appl. No.: 15/806,781

(22) Filed: Nov. 8, 2017

Related U.S. Application Data
(60) Provisional application No. 62/419,865, filed on Nov. 9, 2016.

(51) Int. Cl. H04R 1/10

(52) U.S. Cl. CPC H04R 1/1025; H04R 2420/07; H04R 2460/17

(57) ABSTRACT

Modular cordless earbuds structured to be carried, charged, and connected in different wearable and storage forms are provided. In some embodiments, the earbuds are modularized such that the earbuds can be combined with other compatible accessory products, including a bracelet, a pendant, a charging case, and a charging station. In some embodiments, a companion application is used to control and/or receive signals from the earbuds.

### RELATED APPLICATIONS

This application claims benefit of priority under 35 U.S.C. section 119(e) of the co-pending U.S. Provisional Patent Application Ser. No. 62/419,865, filed Nov. 9, 2016, entitled “Modular Wireless Earbuds,” which is hereby incorporated by reference in its entirety.

### FIELD OF THE INVENTION

The present invention relates to the field of electronic devices. More specifically, the present invention relates to modular wireless earbuds.

### BACKGROUND OF THE INVENTION

Traditional headphones and earbuds are bulky and hard to carry. There exists a need for improvements in earbud technologies to better user convenience.

### SUMMARY OF THE INVENTION

Modular cordless earbuds structured to be carried, charged, and connected in different wearable and storage forms are provided. In some embodiments, the earbuds are modularized such that the earbuds can be combined with other compatible accessory products, including a bracelet, a pendant, a charging case, and a charging station. In some embodiments, a companion application is used to control and/or receive signals from the earbuds. Other features and advantages of the present invention will become apparent after reviewing the detailed description of the embodiments set forth below.

In one aspect, an apparatus is provided. The apparatus includes a body with a receptacle located at each end of the body. The receptacle is sized and shaped to receive an earbud such that the earbuds received in the receptacles forms a pill-shaped modularized electronic device.

In some embodiments, a bottom of the receptacle includes charging pins that electrically couple with charging touch points of the earbud.

In some embodiments, the body includes an external charger connection.

In some embodiments, the external charger connection includes two connector lines separated by insulation material.

In some embodiments, the pill-shaped modularized electronic device charges the earbuds via the external charger connection.

In another aspect, an earbuds system is provided. The system includes a pair of earbuds, and a connector including a body with a receptacle located at each end of the body. The receptacle is sized and shaped to receive a portion of one of the earbuds such that the earbuds received in the receptacles of the connector forms a pill-shaped modularized electronic device.

In some embodiments, each of the earbuds includes an elongated body, wherein the elongated body includes an exterior end and a front speaker chamber at an opposite end of the exterior end.

In some embodiments, the system also includes a cushion/cap for each of the earbuds.

In some embodiments, the front speaker chamber has a smaller cross section than that of the exterior end. A tip of the front speaker chamber includes charging touch points.

In some embodiments, a bottom surface at the exterior end includes a light indicator.

In some embodiments, a bottom of the receptacle includes charging pins that electrically couple with the charging touch points at the tip of the front speaker chamber.

In some embodiments, the connector includes charging lines located on the exterior circumference of the connector, between the receptacles. The charging lines are an external charger connection with an external energy source.

In some embodiments, the system also includes an accessory, wherein the pill-shaped modularized electronic device is integrated with the accessory. In some embodiments, the external energy source is the accessory. In some embodiments, the accessory is wearable.

In some embodiments, the system also includes a companion software application. The companion software application monitors battery level in each earbud. In some embodiments, the companion software application connects and interacts with a voice command assistant.

In yet another aspect, a method of a pill-shaped modularized electronic device is provided. The method includes obtaining a connector and a plurality of earbuds, inserting one of the earbuds into each end of the connector, thereby forming the pill-shaped modularized electronic device, and integrating the pill-shaped modularized electronic device with an accessory.

In some embodiments, the accessory is wearable.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIGS. 1A-1E illustrate different perspectives of an exemplary cordless earbud in accordance with some embodiments.

FIG. 2 illustrates an exemplary connector in accordance with some embodiments.

FIG. 3A-3B illustrate an exemplary earbuds modular system in accordance with some embodiments.

FIGS. 4A-4C illustrate different perspectives of an exemplary stationary charger in accordance with some embodiments.

FIGS. 5A-5C illustrate different perspectives of an exemplary portable charger in accordance with some embodiments.

FIGS. 6A-6B illustrate different perspectives of an exemplary pendant in accordance with some embodiments.

FIGS. 7A-7B illustrate different perspectives of an exemplary bracelet in accordance with some embodiments.

FIG. 8 illustrates an exemplary method of using a pill-shaped module in accordance with some embodiments.

### DETAILED DESCRIPTION OF THE INVENTION

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

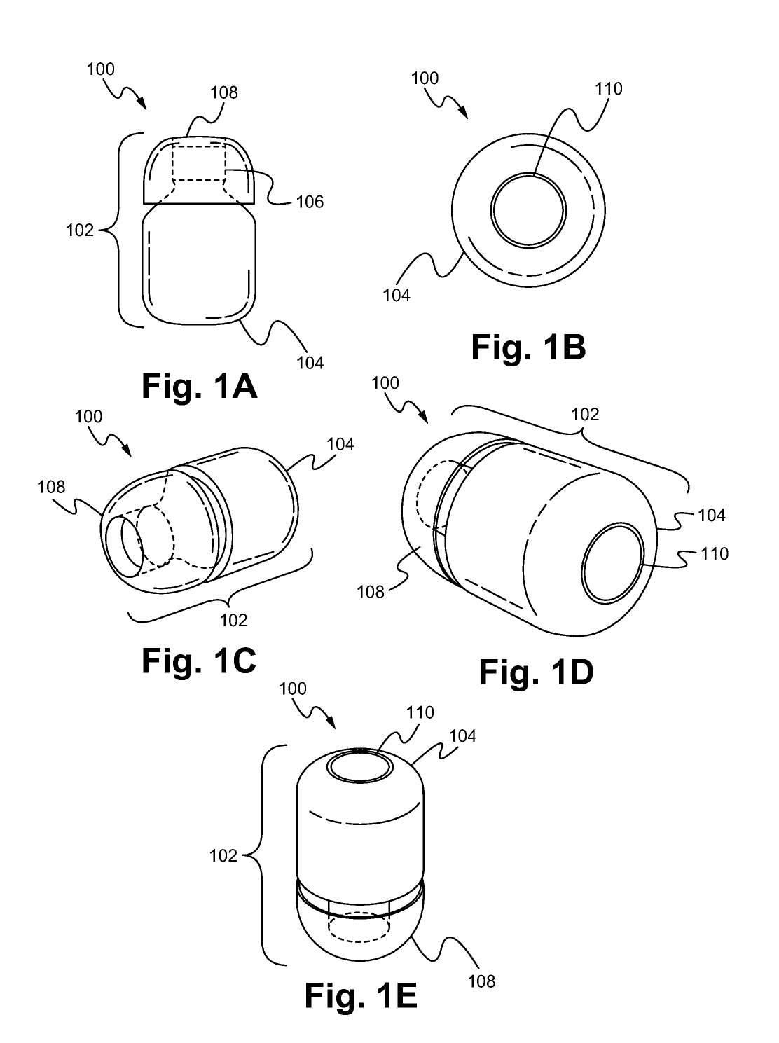

FIGS. 1A-1E illustrate different perspectives of an exemplary cordless earbud 100 in accordance with some embodiments. The earbud 100 has an elongated body 102. In some embodiments, the length of the body 102 is smaller than the diameter of a United States penny. This small form factor makes the earbud 100 easy to wear and carry. In addition, the small form factor also improves the earbud's ability to integrate with other accessories, which are further discussed below.

At least a portion of the body 102 is ceramic. The ceramic body 102 provides durability and is lightweight, scratch-resistant, and has a comfortable surface temperature. The ceramic body 102 also improves BLUETOOTH wireless connections and enables superior sound quality. In some embodiments, the structure of the earbud 100 provides no visible parting line due to ceramic injection used in a molding process, which improves portability, improves assembly efficiency, and makes the earbud 100 waterproof. In some embodiments, a mirror finish of the ceramic body 102 is used to add a high gloss reflective effect.

The body 102 includes an exterior end 104 and a front speaker chamber 106 located at an end opposite the exterior end 104. An ear cushion/cap 108 is sized and shaped to fit over and substantially surround the front speaker chamber 106, which has a smaller cross section than that of the exterior end 104. A tip of the front speaker chamber 106 includes charging touch points, which are electrically coupled with charging pins of a charging region when the earbud 100 is being charged. In some embodiments, a portion of the charging touch points corresponds to a positive phase and another portion of the charging touch points corresponds to a negative phase. Alternatively, the charging touch points correspond to one phase while an area of the body 102, such as below the speaker chamber 106, includes charging touch points that correspond to the opposite phase.

In some embodiments, a portion of the body 102 is cylindrical with the exterior end 104 being rounded. A light indicator 110 is located at a bottom of the body 102, at the exterior end 104. The light indicator 110 is activated when the earbud 100 is powered on, is being charged, or both. As illustrated in FIGS. 1B, 1D, and 1E, the light indicator 110 is in the shape of a ring at the bottom surface of the body 102, although the light indicator can be in any shape and located elsewhere on the body 102. In some embodiments, the light indicator 110 is a translucent LED.

In some embodiments, the earbud 100 also has built-in a microphone. The earbud 100 can be easily paired with any BLUETOOTH-enabled device. This connectively provides convenience and enables listening on a range of devices.

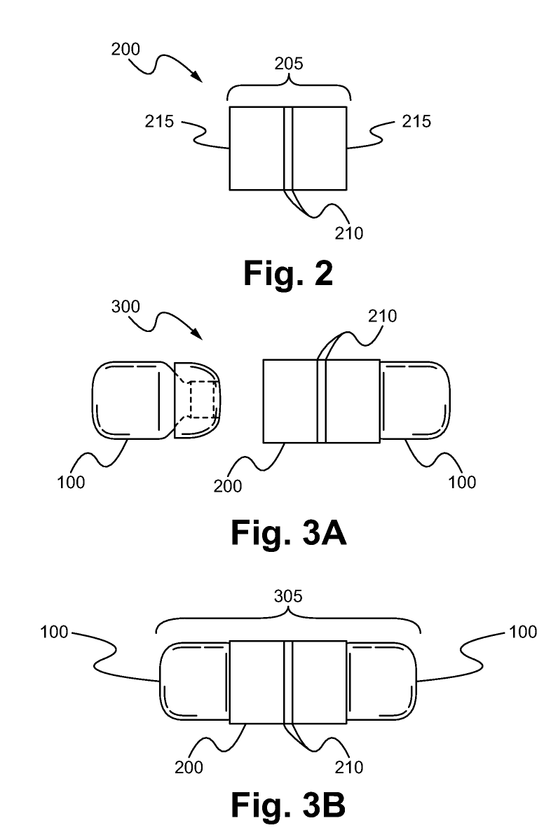

FIG. 2 illustrates an exemplary connector 200 in accordance with some embodiments. The connector 200 has a cylindrical body 205 with a receptacle 215 at each end of the body 205. At least a portion of the body 205 is also ceramic. Each receptacle 215 is sized and shaped to receive a front speaker chamber of an earbud, such as the earbud 100 of FIG. 1. The bottom of each receptacle 215 includes a charging region. The charging region has charging pins that correspond with the charging touch points of an earbud 100 and that are for charging the earbud 100 when the charging touch points of the earbud 100 are electrically coupled with the charging pins of the connector 200. In some embodiments, a portion of the wall of the receptacle 215 also includes a charging region with charging pins. The connector 200 can simultaneously charge two earbuds 100 at a time and can also individually charge one earbud 100 at a time.

In some embodiments, the connector 200 includes an internal battery to store charge that is used for charging the earbuds 100 when the connector 200 is not coupled with an external energy source. When the connector 200 is coupled with an external energy source, connector lines (positive and negative) 210 on the connector 200 function as an external charger connection with that external energy source. The connector lines 210 fully circle around the external circumference of the body 205 and are separated/spaced by insulation material. The connector 200 includes internal electronic components to receive wireless charging when the connector 200 is coupled with the external energy source. The electronic components allow for ultra fast charging of the internal battery of the connector 200, the earbud(s) 100, or all simultaneously. With such a fast charging capacity, downtime between use is minimized. Five hours of use provides a user with ample uninterrupted time for their listening/talking pleasure. In some embodiments, fifteen minutes of charging the earbuds 100 yields one hour of use (e.g., music/talk time).

FIG. 3A-3B illustrate an exemplary earbuds modular system 300 in accordance with some embodiments. The earbuds modular system 300 includes two earbuds 100 and the connector 200. As illustrated in FIG. 3B, the two earbuds 100 are plugged into the connector 200, one at each end of the connector 200, to form a pill-shaped module 305. In some embodiments, the module 305 is a pill-shaped modularized electronic device. When an earbud 100 is plugged into the connector 200, the exterior end 104 of that earbud 100 extends beyond the body 205 of the connector 200. The pill-shaped module 305 can be standalone and is suitable for carrying when the earbuds 100 are not in use. However, the pill-shaped module 305 is also able to be integrated into an accessory for charging (e.g., using the charging lines 210), carrying, storage, and/or other uses. The pill-shaped module 305, together with a wearable accessory, can be transformed into a wearable device.

An exemplary accessory is a stationary charger, a portable charging case, a bracelet, or a pendant. The bracelet accessory and the pendant accessory are each a wearable storage such that when used with the pill-shaped module 305, transforms the pill-shaped module 305 into a wearable device that can fit with the user's lifestyle. Although each of these accessories are discussed in turn below, other wearable accessories are contemplated. The system 300 can include one or more accessories.

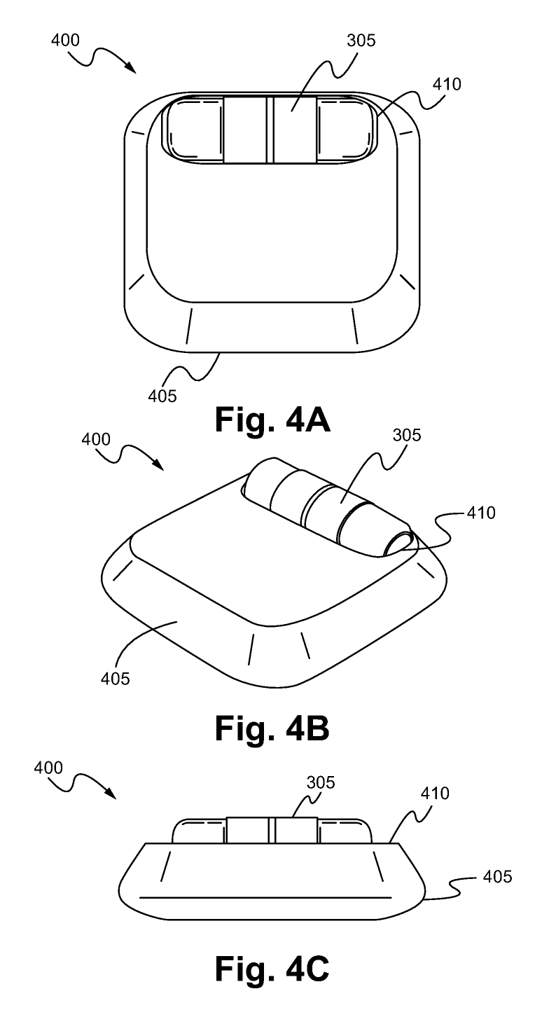

FIGS. 4A-4C illustrate different perspectives of an exemplary stationary charger 400 in accordance with some embodiments. The stationary charger 400 has a substantially planar body 405 with a receptacle 410 at a top of the body 405 and a flat surface at a bottom of the body 405. The receptacle 410 is sized and shaped to receive a pill-shaped module, such as the pill-shaped module 305 of FIG. 3B. The body 405 houses electronic components that allow for ultra fast charging of the pill-shaped module 305 via the charging lines 210 on the connector 200 of the pill-shaped module 305. When in use, the stationary charger 400 can charge the earbud(s) 100 via the connector 200, the connector 200, or all simultaneously.

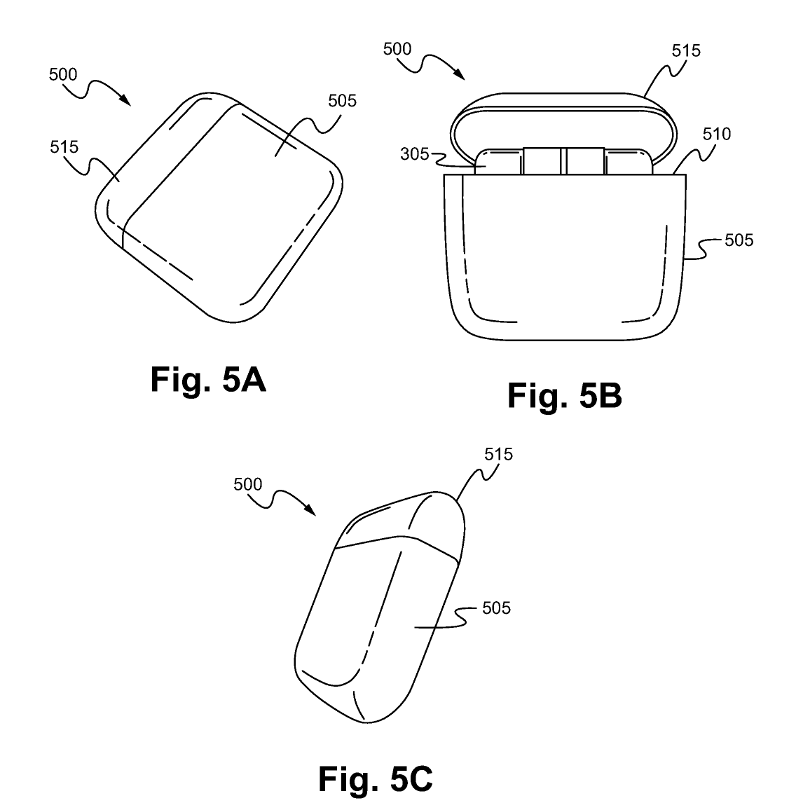

FIGS. 5A-5C illustrate different perspectives of an exemplary portable charger 500 in accordance with some embodiments. The portable charger 500 has a substantially slender and sleek body 505 with a receptacle 510 at a top of the body 505. The receptacle 510 is sized and shaped to receive a pill-shaped module, such as the pill-shaped module 305 of FIG. 3B. The body 505 houses electronic components that allow for ultra fast charging the pill-shaped module 305 via the charging lines 210 on the connector 200 of the pill-shaped module 305. When in use, the portable charger 500 can charge the earbud(s) 100 via the connector 200, the connector 200, or all simultaneously. The portable charger 500 also includes a cover 515 for coupling with the body 505 and enclosing the pill-shaped module 305 therein. The cover 515 can be removably coupled or, alternatively, hingedly coupled with the body 505. The cover 515 secures the pill-shaped module 305 in place while the portable charger 500 is being carried.

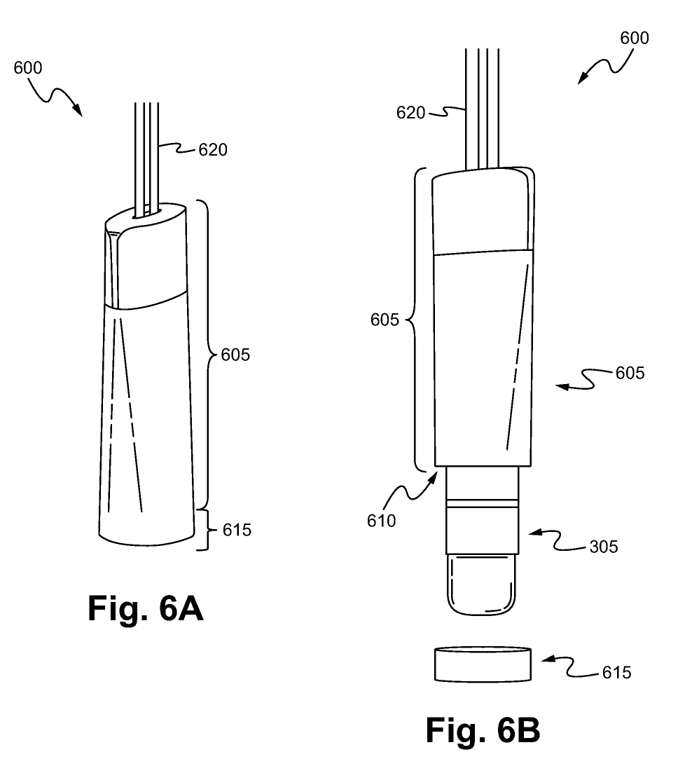

FIGS. 6A-6B illustrate different perspectives an exemplary pendant 600 in accordance with some embodiments. The pendant 600 includes an elongated body 605, a cover 615, and a cord 620. The cord 620 can be coupled to the body 605 and/or the cover 615. In FIGS. 6A-6B, the cord 620 is coupled with one end of the body 605; the body 605 is positioned between the cord 620 and the cover 615 such that the pendant 600 hangs vertically when worn. Alternatively, the cord 620 can be coupled with the cover 615 such that the cover 615 is positioned between the cord 620 and the body 605. Alternatively, the cord 620 can be coupled at a central location on the body 605 such that the pendant 600 is horizontal when worn. Alternatively, the cord 620 can be coupled with both the body 620 and the cover 614. Regardless of how the cord is coupled, the body 605 has a receptacle/cavity 610 that is sized and shaped to receive a pill-shaped module, such as the pill-shaped module 305 of FIG. 3B. The cover 615 can be removably coupled or, alternatively, hingedly coupled with the body 605, to enclose the pill-shaped module 305 therein. The cover 615 secures the pill-shaped module 305 in place while the pendant 600 is being worn.

However, in some embodiments, the exterior surface of the pill-shaped module 305 has a structure that corresponds to a matching/corresponding structure in the cavity 610 such that the pill-shaped module 305 can be engaged inside and snugly fits within the cavity 610 without the use of the cover 615. In some embodiments, the body 605 houses electronic components that allow for ultra fast charging of the pill-shaped module 305 via the charging lines 210 on the connector 200 of the pill-shaped module 305. When in use, the pendant 600 can charge the earbud(s) 100 via the connector 200, the connector 200, or all simultaneously.

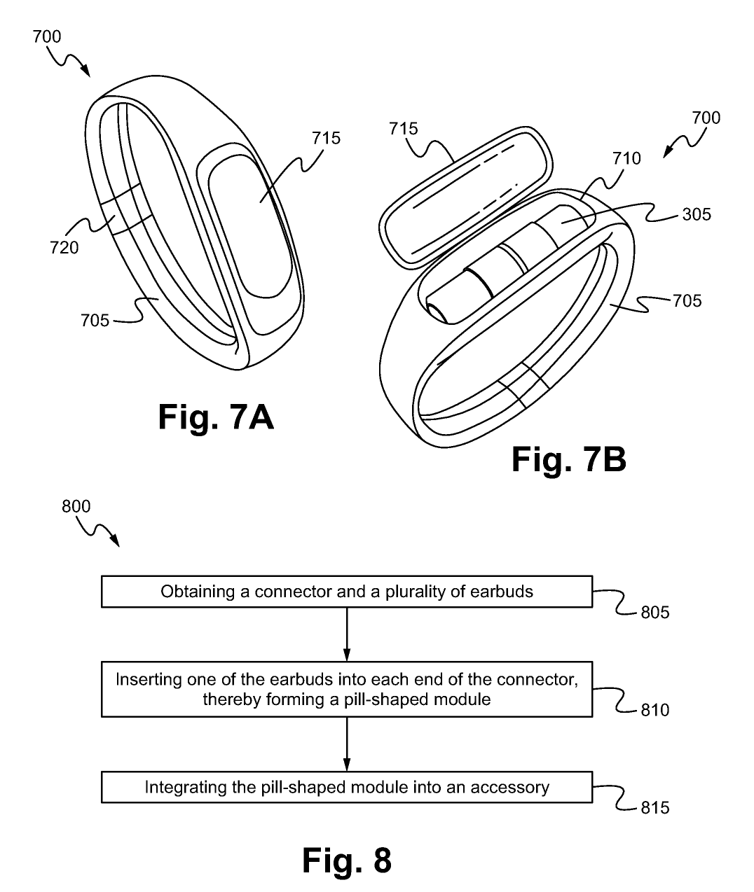

FIGS. 7A-7B illustrate different perspectives of an exemplary bracelet 700 in accordance with some embodiments. The bracelet 700 includes a body 705 and a cover 715. The body 705 is in a form of a band, and the bracelet can include a clasp 720 or the like to tighten and loosen the band. The body 705 has a receptacle/cavity 710 that is sized and shaped to receive a pill-shaped module, such as the pill-shaped module 305 of FIG. 3B. The cover 715 can be removably coupled or, alternatively, hingedly coupled with the body 705, enclosing the pill-shaped module 305 therein. The cover 715 secures the pill-shaped module 305 in place while the bracelet 700 is being worn. In some embodiments, the body 705 houses electronic components that allow for ultra fast charging the pill-shaped module 305 via the charging lines 210 on the connector 200 of the pill-shaped module 305. When in use, the bracelet 700 can charge the earbud(s) 100 via the connector 200, the connector 200, or all simultaneously.

It should be noted that although the charging of the pill-shaped module 305 via the charging lines 210 has been described, other charging technologies (e.g., wireless recharging circuits) are contemplated. For example, Qi wireless charging technology can be used to charge the pill-shaped module 305.

The earbuds 100 are paired with a computing device, such as a mobile device, using BLUETOOTH or the like. After the earbuds 100 are paired, audio is provided from the mobile device to the earbuds 100. The earbuds 100 provide true stereo sound with distinctive left and right channels, and provide superior sound quality with noise reduction and echo cancellation. The system 300 also includes a companion application, which can run on the mobile device. The earbuds 100 can be controlled and/or monitored by the companion application. In some embodiments, the earbuds 100 can also control the companion application The companion application provides for a smart user experience. For example, when the earbuds 100 are communicatively coupled with the companion application, battery level in each earbud is monitored, and energy and auto-charging levels can be customized via the companion application. In some embodiments, the companion application is AI-enabled, which connects and interacts with the device's default voice command assistant, such as SIRI or GOOGLE NOW, providing a hands-free experience. The user is able to use voice commands to retrieve daily briefing or to schedule pickup with the LYFT rideshare service, all without the touch of a button. The user simply speaks, which is captured by the microphone in one or both of the earbuds 100.

FIG. 8 illustrates an exemplary method 800 of using a pill-shaped module in accordance with some embodiments. The method 800 begins at a Step 805, where a connector and a plurality of earbuds are obtained. In some embodiments, the connector is similarly configured as the connector 200 of FIG. 2. In some embodiments, each of the earbuds is similarly configured as the earbud 100 of FIGS. 1A-1E.

At a Step 810, one of the earbuds is inserted into each end of a connector to form a pill-shaped module. In some embodiments, the pill-shaped module charges one or both of the earbuds.

At a Step 815, the pill-shaped module is integrated with an accessory. An exemplary accessory is a stationary charger, a portable charging case, a bracelet, or a pendant. In some embodiments, the accessory is wearable.

To utilize, the earbuds are removed from the connector and placed in the user's ears. When the user no longer needs to use the earbuds, the earbuds are removed from the user's ears and plugged into the connector, forming the pill-shaped module. The pill-shaped module can be integrated with an accessory. The accessory can be worn by the user.

In operation, the earbuds can be controlled and/or monitored by the companion application running on the user's device that is paired with the earbuds. When the earbuds are plugged into the connector, thus forming the pill-shaped module, the connector charges the earbuds. The pill-shaped module can be coupled with an accessory. The accessory can be used for charging, carrying, and/or storing the pill-shaped module.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. An apparatus comprising a body with a receptacle located at each end of the body, wherein the receptacle is sized and shaped to receive an earbud such that the earbuds received in the receptacles form a pill-shaped modularized electronic device.

2. The apparatus of claim 1, wherein a bottom of the receptacle includes charging pins that electrically couple with charging touch points of the earbud.

3. The apparatus of claim 2, wherein the body includes an external charger connection.

4. The apparatus of claim 3, wherein the external charger connection includes two connector lines separated by insulation material.

5. The apparatus of claim 4, wherein the pill-shaped modularized electronic device charges the earbuds via the external charger connection.

6. An earbuds system comprising:
a pair of earbuds; and
a connector including a body with a receptacle located at each end of the body, wherein the receptacle is sized and shaped to receive a portion of one of the earbuds such that the earbuds received in the receptacles of the connector form a pill-shaped modularized electronic device.

7. The earbuds system of claim 6, wherein each of the earbuds includes an elongated body, wherein the elongated body includes an exterior end and a front speaker chamber at an opposite end of the exterior end.

8. The earbuds system of claim 7, further comprising a cushion/cap for each of the earbuds.

9. The earbuds system of claim 8, wherein the front speaker chamber has a smaller cross section than that of the exterior end.

10. The earbuds system of claim 9, wherein a tip of the front speaker chamber includes charging touch points.

11. The earbuds system of claim 10, wherein a bottom surface at the exterior end includes a light indicator.

12. The earbuds system of claim 11, wherein a bottom of the receptacle includes charging pins that electrically couple with the charging touch points at the tip of the front speaker chamber.

13. The earbuds system of claim 12, wherein the connector includes charging lines located on the exterior circumference of the connector, between the receptacles, wherein the charging lines are an external charger connection with an external energy source.

14. The earbuds system of claim 13, further comprising an accessory, wherein the pill-shaped modularized electronic device is integrated with the accessory.

15. The earbuds system of claim 14, wherein the external energy source is the accessory.

16. The earbuds system of claim 14, wherein the accessory is wearable.

17. The earbuds system of claim 14, further comprising a companion software application, wherein the companion software application monitors battery level in each earbud.

18. The earbuds system of claim 17, wherein the companion software application connects and interacts with a voice command assistant.

19. A method of a pill-shaped modularized electronic device, comprising:
obtaining a connector and a plurality of earbuds;
inserting one of the earbuds into each end of the connector, thereby forming the pill-shaped modularized electronic device; and
integrating the pill-shaped modularized electronic device with an accessory.

20. The method of claim 19, wherein the accessory is wearable.
